(19) United States
(12) Patent Application Publication
(10) Pub. No.: US 2026/0061893 A1
(43) Pub. Date: Mar. 5, 2026

(54) COVER, RAIL WITH A COVER, AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 19/314,247

(22) Filed: Aug. 29, 2025

(30) Foreign Application Priority Data
Sep. 4, 2024 (DE) 10 2024 208 403.4
Feb. 17, 2025 (DE) 10 2025 105 876.8

(51) Int. Cl. B60N 2/07

(52) U.S. Cl. CPC B60N 2/0725; B60N 2/0715

(57) ABSTRACT

A cover for a rail element of a longitudinal adjustment device may have at least one carrier. The carrier is in the form of a plastics profile into which a plurality of clips are integrated which are spaced apart from one another along the longitudinal extent of the plastics profile and are each in the form of a rotary wedge. A rail element and vehicle utilizing the cover are also provided.

### FIELD

The invention relates to a cover for a rail, to a rail having such a cover, and to a vehicle seat having a longitudinal adjustment device with a rail having a cover.

### BACKGROUND

DE 10 2016 224 588 A1 discloses a longitudinal adjuster having a rail assembly, comprising a lower rail and an upper rail, which is movably connected to the lower rail. Also disclosed is a cover (for example a rubber cover, a brush cover, etc.), which is connected to an outer profile of the lower rail and which is arranged such that it covers at least a part of an inner profile.

The invention addresses the problem of providing an improved cover of the type mentioned at the beginning, in particular an easily fittable and securely fixable cover for a rail, a rail having such an improved cover, and a corresponding vehicle seat.

### SUMMARY

The first problem is solved according to the invention by the features specified in claim 1. The second problem is solved according to the invention by the features specified in claim 10. The third problem is solved according to the invention by the features specified in claim 13.

The first problem is solved according to the invention by a cover for a rail element (also referred to as rail), wherein the cover (also referred to as rail cover) comprises at least one carrier which is in the form of a plastics profile into which a plurality of clips are integrated which are spaced apart from one another along the longitudinal extent of the carrier. Each clip is in the form of a rotary wedge.

Since the carrier is in the form of a plastics profile, the cover can be manufactured in a simple tool, in particular in a plastic mold with less material use and lower profile tolerances and at the same time with integrated locking elements in the form of clips.

The clips can be lateral clips. In this case, the plastics profile can be fastened to a rail element, or a rail, laterally via clip-fastening connections. As a result, the carrier in the form of a plastics profile, said carrier also being referred to as a plastics carrier, can be fastened only to in each case one side flank of the rail element, for example a lower rail. Depending on the length of the rail element, it is also possible for a plurality of these carriers to be fastened to the rail element in succession and on both sides.

As a result, it is possible to dispense with a conventional cover, which is guided around the rail element, beneath the rail element, for example the lower rail, from one side to the other side. Such a cover requires more installation space, high assembly effort and is vulnerable to tolerances.

Each clip may have at least one undercut, which is in the form, in particular, of a rotary wedge.

Each clip may be pivotable about a pivot point. The pivot point may be arranged by way of a movable, in particular articulated, wedge portion of the rotary wedge.

Each clip may be preloaded in a direction oriented perpendicularly to the longitudinal extent. Each clip may be formed in an elastic and/or reversibly flexible manner.

Each clip may be preloaded in the direction oriented perpendicularly to the longitudinal extent as a result of elasticity of the plastic of the carrier. As a result, the clips can be kept pressed in each case in the direction of the rail element. The plastics profile may be arranged or arrangeable on the rail element without play. It is also possible for automatic locking of the clips and thus of the carrier on the rail element to be ensured.

Each clip may be pivotable about an axis of rotation oriented along the longitudinal extent.

Each clip may have at least one locking contour. Each locking contour may be in the form of a wedge surface at a free arm end of each clip.

The plastics profile may have a plurality of cutouts, which are spaced apart from one another along the longitudinal extent. A clip may be assigned to each cutout. In particular, each rotary wedge may be formed by cutting out or punching out a surface in the plastics profile.

Each clip may be arranged in a protruding manner on one side of the cutout. Each clip may be connected to the cutout on this side and form the pivot point. As a result, a one-piece plastics carrier with integrated clips can be formed easily.

The plastics profile may have a plurality of recesses for a latching plate of the longitudinal adjustment device, in particular for receiving detents, and/or for a cover-strip fastener of a cover strip. The clips and the recesses may be arranged alternately along the longitudinal extent of the plastics profile.

The plastics profile may have at least one undercut. The undercut may be arranged at a distance from the clips. The undercut may be oriented substantially parallel to the clips. The undercut may be intended to keep the plastics profile on the rail element, for example counter to forces that may act in the direction of the transverse extent of the rail element.

The undercut may be formed by suitable forming, in particular by bending, at a free leg end of the plastics profile.

The plastics profile may have a first leg portion and a perpendicularly protruding second leg portion connected to the first leg portion. The undercut may be formed at a free leg end of the first leg portion. The plurality of clips may be integrated or formed in the second leg portion.

The plastics profile may be substantially J-shaped. Alternatively, the plastics profile may be substantially L-shaped.

The plastics profile may have a second leg portion that is longer relative to the first leg portion. The shape of the plastics profile corresponds to a conventional side-flank shape of a lower rail. Such a lower rail may have, for example, a rail bottom with two rails legs protruding vertically upward, wherein the rail legs may each be bent inward at their free leg ends. Each rail leg is also referred to as side flank.

The plastics profile may have a shape corresponding to the respective rail leg. As a result of the undercut and the lateral clips, the plastics profile can be fastened to the rail element largely by way of a form-fit.

The plastics profile may have a first leg portion extending continuously along the longitudinal extent. A plurality of second leg portions may protrude from the first leg portion. The leg portions may be arranged in a manner spaced apart from one another along the longitudinal extent. The leg portions may each have at least one clip or a plurality of clips. Alternatively, the plastics profile may have a second leg portion formed continuously along the longitudinal extent.

The plastics profile may have a continuous undercut extending along the longitudinal extent of the plastics profile. The undercut may be provided with interruptions.

The second problem is solved according to the invention by a rail element (also referred to as rail), in particular by a lower rail of a longitudinal adjustment unit (also referred to as longitudinal adjustment device), wherein the rail comprises the above-described cover and has, along the longitudinal extent, a number of through-openings which are formed in a manner corresponding to the clips.

The rail element, in particular the lower rail, may comprise at least one rail bottom and two rail legs protruding perpendicularly therefrom. At least one cover may be arranged on, in particular fastened to, at least one of the rail legs.

For example, each clip may pass into self-locking operative engagement in the associated through-opening by means of the rotary wedge. In particular, each clip has been brought or is able to be brought into self-locking operative engagement in the associated through-opening by means of the rotary wedge such that pulling, in particular traction, on a free end of the cover does not result in the self-locking operative engagement being reversed. For example, the cover can be arranged on the rail such that it is pivotable about a predefined pivot point of the rotary wedge.

The rail leg may have a free leg end, wherein the undercut of the cover engages around or behind the free leg end in the mounted state. This prevents the cover, in particular the carrier in the form of a plastics profile, from being able to be moved laterally away from the rail element. The carrier may be held on the rail element largely without play. The carrier can withstand forces in all directions during vehicle operation.

In addition, the cover may comprise a cover strip which is able to be fastened releasably to the carrier. The cover strip may be a visual facing strip. For example, the lower rail may be arranged below a floor surface of the vehicle. As a result of the cover strip, a floor opening in the vehicle floor can be covered. The cover strip may be fastened to the carrier via connecting elements. The cover strip may have connecting elements which latch in place in recesses in the carrier. In one development, the cover strip may be provided to cover a rail opening between the rail legs of the lower rail.

The third problem is solved according to the invention by a vehicle seat which comprises a longitudinal adjustment unit which comprises the above-described rail with a cover.

Advantageous embodiments, which can be used individually or in combination with one another, will be described in the following text.

### DESCRIPTION OF THE FIGURES

In the following text, the invention is explained in more detail by way of advantageous exemplary embodiments illustrated in the figures. The invention is not limited to these exemplary embodiments, however. In the figures:

FIG. 1: shows a schematic illustration of a vehicle seat having a longitudinal adjustment device,

FIG. 2: shows a perspective view of a rail having a cover on both sides,

FIG. 3: shows a perspective view of a rail having a cover on one side,

FIG. 4: shows an enlarged detail of the perspective view of the rail in the region of a coupling of the rail and cover,

FIG. 5: shows a sectional illustration of FIG. 4 in the region of the coupling of the rail and cover,

FIG. 6: shows a front view of the rail with the cover on both sides, and

FIG. 7: shows a sectional illustration of FIG. 6 in the region of the coupling of the rail and the two covers.

### DETAILED DESCRIPTION

Mutually corresponding parts are provided with the same reference signs in all the figures.

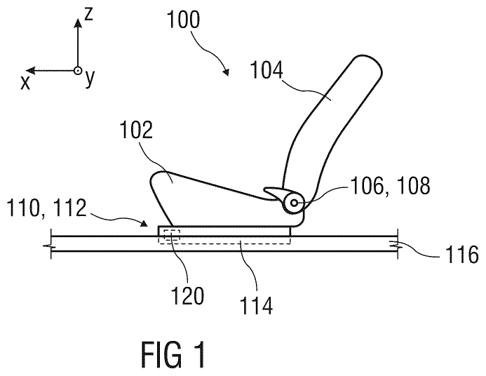

A prior art vehicle seat 100 schematically illustrated in FIG. 1 will be described in the following text using three spatial directions extending perpendicularly to one another. A longitudinal direction x extends, in the case of a vehicle seat 100 installed in the vehicle, largely horizontally and preferably parallel to a vehicle longitudinal direction, which corresponds to the usual direction of travel of the vehicle. A transverse direction y extending perpendicularly to the longitudinal direction x is likewise oriented horizontally in the vehicle and extends parallel to a vehicle transverse direction. A vertical direction z extends perpendicularly to the longitudinal direction x and perpendicularly to the transverse direction y. In the case of a vehicle seat 100 installed in the vehicle, the vertical direction z extends preferably parallel to a vehicle vertical axis.

The position and direction indications used, for example front, rear, top and bottom relate to a direction of view of an occupant sitting in the vehicle seat 100 in a normal sitting position, wherein the vehicle seat 100 is installed in the vehicle in a position of use suitable for conveying people with an upright backrest 104, and is oriented as usual in the direction of travel. The vehicle seat 100 can, however, also be installed or moved in a different orientation, for example transversely to the direction of travel. Unless described otherwise, the vehicle seat 100 is installed mirror-symmetrically to a plane extending perpendicularly to the transverse direction y.

The backrest 104 can be arranged pivotably on a seating part 102 of the vehicle seat 100. To this end, the vehicle seat 100 can optionally comprise a fitting 106, in particular a setting fitting, a rotary fitting, a latching fitting or a swashplate fitting.

The position and direction indications used, for example radial, axial and in the circumferential directions, relate to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110 (also referred to as longitudinal adjustment unit). The longitudinal adjustment device 110 comprises, for example, a rail arrangement 112 with a first rail element 114 and a second rail element 116. The first rail element 114 is adjustable in the longitudinal direction x relative to the second rail element 116. The first rail element 114 is fastened to the seating part 102. The second rail element 116 is fastened to a structural element of a vehicle, for example a vehicle floor.

For greater clarity, the first rail element 114 is referred to as upper rail 114 in the following description. This upper rail 114 (also referred to as running rail or slide) is assigned to the vehicle seat 100 and designed to carry this vehicle seat 100. The second rail element 116 is referred to as lower rail 116 in the following text. The lower rail 116 is connected fixedly and for example to the floor of a vehicle or some other suitable vehicle structure.

The rail arrangement 112 may have at least one cover 120.

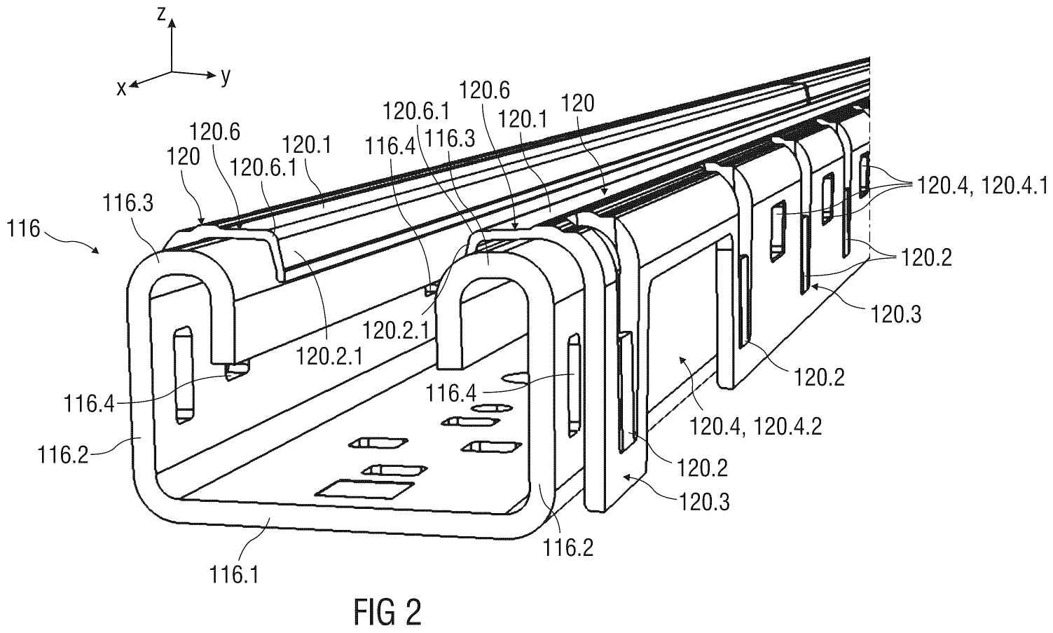

FIG. 2 shows a perspective view of a lower rail 116 with a cover 120 on both sides.

The lower rail 116 is in the form, in particular, of a profile component, in particular of a metal profile component. The lower rail 116 may be formed, for example, as a U-shaped profile component with a rail bottom 116.1, from which two rail legs 116.2 extend vertically upward. Free leg ends 116.3 may additionally have been bent inwardly in a u-shape.

The lower rail 116 may comprise a cover 120 (also referred to as rail cover) on each rail leg 116.2.

Each cover 120 comprises at least one carrier 120.1, which is in the form of a plastics profile.

A plurality of clips 120.2 are integrated in each carrier 120.1 along its longitudinal extent (in the longitudinal direction x), this being apparent only at the front/right-hand carrier 120.1 in FIG. 2.

The clips 120.2 have been introduced into the associated carrier 120.1 in a manner spaced apart from one another along the longitudinal extent.

Since each carrier 120.1 is in the form of a plastics profile, the cover 120 can be manufactured in a simple tool, in particular in a plastic mold with less material use and lower profile tolerances.

For attaching and fixing each carrier 120.1, the lower rail 116 comprises, along the longitudinal extent, a number of through-openings 116.4, which are formed in a manner corresponding to the clips 120.2.

The clips 120.2 may be integrated in the carrier 120.1 at uniform distances from one another. The lower rail 116 has at least a number of through-openings 116.4 corresponding to the number of clips 120.2 or a greater number thereof.

Each carrier 120.1 is in the form of an L-profile or J-profile. The clips 120.2 are integrated in the second leg portion 120.3 of the respective carrier 120.1, which is in contact with the associated rail leg 116.2 in the mounted state.

The clips 120.2 protrude from the carrier 120.1 in the direction of the rail leg 116.2 and pass into engagement in the associated through-opening 116.4. The clips 120.2 may be in the form, for example, of resilient tabs or tongues.

The clips 120.2 may be integrated into the carrier 120.1 as punched tongues or the like.

Furthermore, the leg portion 120.3 may comprise recesses 120.4. The recesses 120.4 may be in the form of passages 120.4.1 and/or of cutouts 120.4.2, in particular of latching recesses.

In this case, the clips 120.2 and the recesses 120.4 can be integrated alternately into the leg portion 120.3 as seen in the longitudinal direction x. For example, the clips 120.2 and the recesses 120.4 can be integrated into the second leg portion 120.3 at uniform distances from one another.

The plastics profile comprises a first leg portion 120.6 and a second leg portion 120.3 that is connected to the first leg portion 120.6 and protrudes vertically downward. An undercut 120.2.1 is formed at a free leg end 120.6.1 of the first leg portion 120.6. The plurality of clips 120.2 are integrated into the second leg portion 120.3.

In other words: The plastics profile is substantially J-shaped and comprises a plurality of clips 120.2 on one side and at least one undercut 120.2.1 on an opposite side.

The undercut 120.2.1 of the plastics profile engages around or behind the free leg end 116.3 in the mounted state.

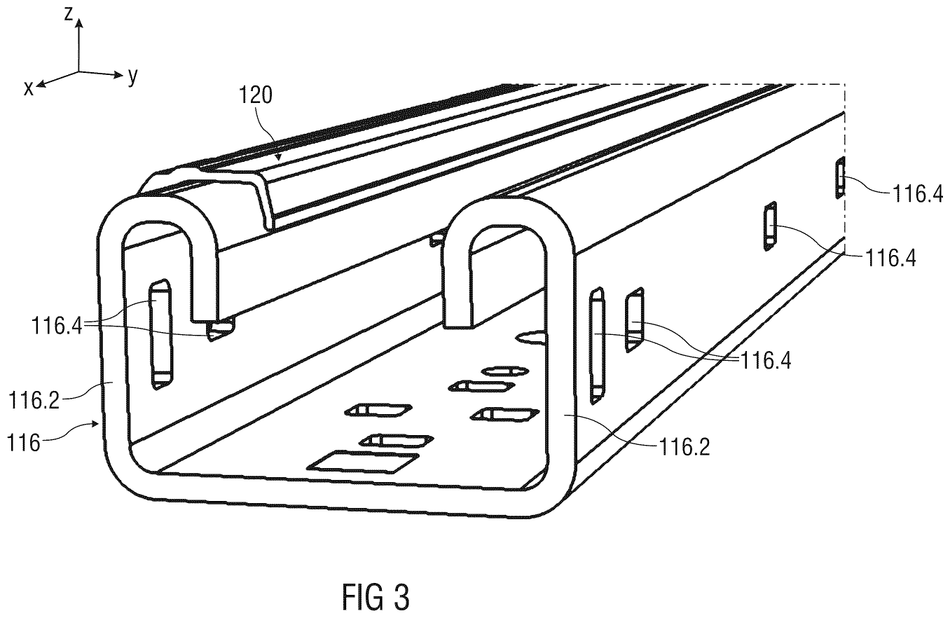

FIG. 3 shows a perspective view of the rail in the form of a lower rail 116, with a cover 120 on one side. The front/right-hand cover 120 has been omitted to illustrate the through-openings 116.4 in the rail leg 116.2 more clearly.

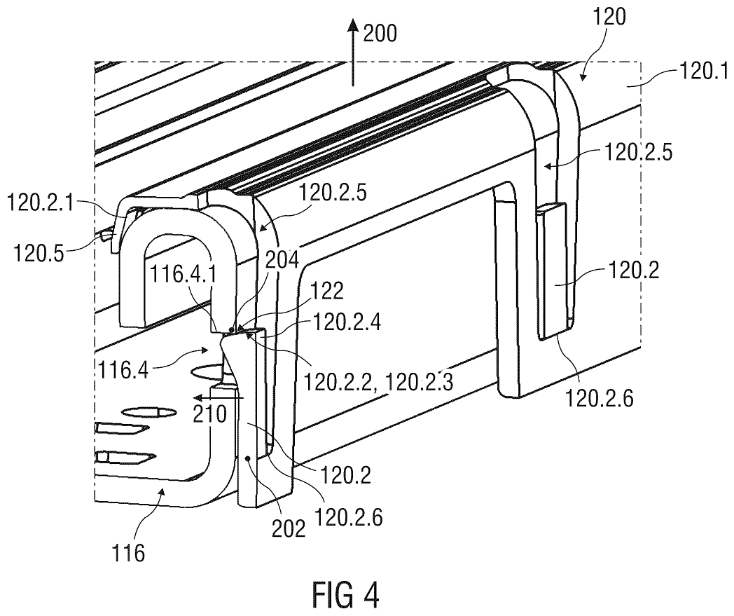

FIG. 4 shows an enlarged detail of the perspective view of the rail in the form of a lower rail 116 in the region of a coupling of the lower rail 116 and cover 120 by means of the clips 120.2 of the carrier 120.1 and the through-openings 116.4 in the lower rail 116.

Each clip 120.2 has at least one undercut 120.2.1 and a rotary wedge 120.2.2.

For example, each clip 120.2 can pass into self-locking operative engagement 122 in the associated through-opening 116.4, in particular at an upper edge 116.4.1 (=upper opening rim), by means of the rotary wedge 120.2.2.

The undercut 120.2.1 prevents the cover 120 from rotating about a contact point 204 of the rotary wedge 120.2.2 at the upper edge 116.4.1.

In other words: In the mounted state, each clip 120.2 is in self-locking operative engagement 122 in the associated through-opening 116.4 by means of the rotary wedge 120.2.2 such that a predefined pull as per the arrow 200 on a free end 120.5 of the cover 120 does not cause the self-locking operative engagement 122 to be reversed. The clip 120.2 is in the form, for example, of a spring clip or spring arm. The rotary wedge 120.2.2 is in the form, for example at the free arm end 120.2.4, of a locking contour 120.2.3, in particular of a wedge surface, or is designed for example in the form of a ramp or the like.

In this case, during the mounting of the carrier 120.1 on the rail leg 116.2, the clip 120.2 engages in a radial direction in the through-opening 116.4 and thus in a wall of the rail leg 116.2, and passes into the self-locking operative engagement 122, in particular by way of a friction fit and/or force-fit, at the upper edge 116.4.1, such that the lower rail 116 and the cover 120 are fixed together so as to be unable to slip or twist.

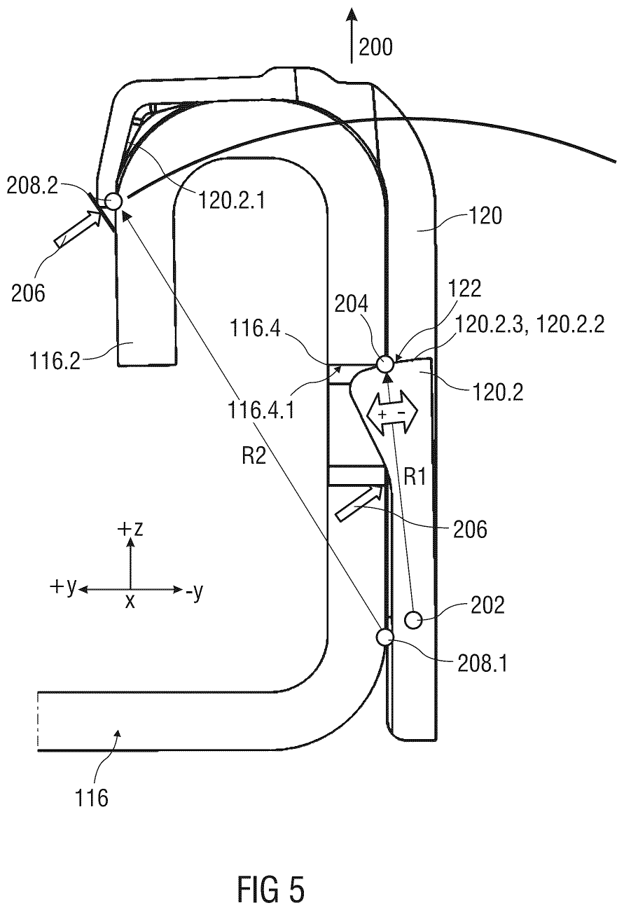

In particular, the cover 120 is arranged on the lower rail 116 such that it is pivotable about a predefined pivot point 202 of the rotary wedge 120.2.2, and such that this cover 120, if an attempt is made to detach it from the lower rail 116, for example by pulling in the direction of the arrow 200, is supported at at least one point, in particular, as seen along a length, along a line at the bearing points 208.1, 208.2 (illustrated in FIG. 5). This at least one bearing point 208.1, 208.2 or line (entire carrier 120.1 (=plastics carrier)) can be considered, so to speak, to be a pivot point or axis of rotation. The undercut 120.2.1 prevents this rotation about this pivot point or axis of rotation.

Each clip 120.2 is mounted pivotably about the pivot point 202. Each clip 120.2 is preloaded in a direction 210 oriented perpendicularly to the longitudinal extent.

The plastics profile comprises a plurality of cutouts 120.2.5. By way of the cutouts 120.2.5, the rotary wedges 120.2.2 can be formed integrally in the plastics profile. The cutouts 120.2.5 are spaced apart from one another along the longitudinal extent.

A clip 120.2 is assigned to each cutout 120.2.5. Each clip 120.2 is arranged in a protruding manner on one side 120.2.6 of the cutout 120.2.5. As a result of the elasticity of the plastic in the region of the connection of each rotary wedge 120.2.2 to the side 120.2.6 of each cutout 120.2.5, each rotary wedge 120.2.2 can be formed in a preloaded manner. Each rotary wedge 120.2.2 pushes in the direction indicated by the arrow 210.

FIG. 5 shows a sectional illustration of FIG. 4 in the region of the coupling of the lower rail 116 and cover 120 in the form of the clip-fastening connection and the retaining function.

The at least one clip 120.2 is arranged such that an upward pull as per the arrow 200, in the vertical direction +z, cannot cause the clip-fastening connection to be undone.

The clip 120.2 comprises the rotary wedge 120.2.2, which forms the locking contour 120.2.3. The rotary wedge 120.2.2 is rotatable about the pivot point 202. By die-cutting, the clip 120.2 is positioned in the transverse direction +y. During mounting, this position of the clip 120.2 may be or may have been changed via the contact, in particular the self-locking operative engagement 122, with the upper edge 116.4.1 of the through-opening 116.4 at the contact point 204.

The contact point 204 may, for example, in the case of a through-opening 116.4 that has been displaced upward on account of tolerances, be located farther in the transverse direction +y and, in the case of a position of the through-opening 116.4 in the opposite direction, farther in the transverse direction −y. This contact point 204 does not change its position in the event of tolerance-related changes in position in the vertical direction z. However, the clip 120.2 does change its position in the transverse direction y in the described manner.

The locking contour 120.2.3 is in the form of a rotary wedge 120.2.2 which can be pivoted about the pivot point 202. Via the elasticity of the plastic of the cover 120, this rotary wedge 120.2.2 is always pressed against the upper edge 116.4.1 of the through-opening 116.4 (also referred to as hole pattern). Thus, the cover 120 (also referred to as cover strip) is play-free in the vertical direction +z.

If an attempt is now made to lift the cover 120 in the vertical direction +z as per the arrow 200, the clip 120.2 will not open since the rotary wedge 120.2.2 is designed in a self-locking manner. A locking direction is indicated by an arrow R1.

If anyone attempts to move the cover 120, in particular the carrier 120.1, laterally in the arrow direction as per arrow 206, this is prevented via the undercut 120.2.1 with respect to the profile. A locking direction is indicated by an arrow R2. This means that in the event of a force in the arrow direction as per arrow 206, the carrier 120.1 in the form of a plastics carrier bears against the lower rail 116 at a first bearing point 208.1 and at a second bearing point 208.2. The first bearing point 208.1 and the second bearing point 208.2 are formed on opposite outer sides of the rail leg 116.2.

Intended rotation about the first bearing point 208.1 is not possible since the second bearing point 208.2 cannot travel along the rail contour, since the clip 120.2, at the contact point 204 with the upper edge 116.4.1 of the through-opening 116.4, prevents any movement in the vertical direction z.

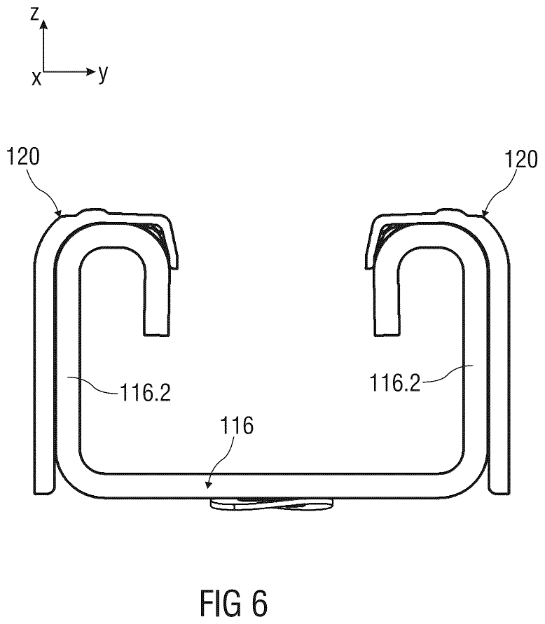

FIG. 6 shows a front view of the lower rail 116 with the cover 120 on both sides. In this case, an associated cover 120 is arranged on each rail leg 116.2, said cover, as described above, being held in a self-locking manner by means of a plurality of clips 120.2 (illustrated in FIG. 5) on the rail legs 116.2 and being fixed without play in the vertical direction z.

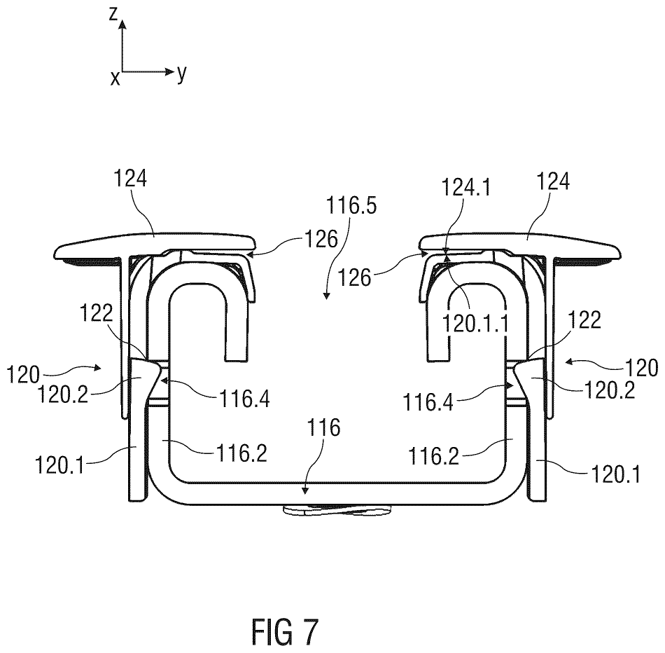

FIG. 7 shows a sectional illustration of FIG. 6 in the region of the coupling of the lower rail 116 and the two covers 120 by means of the clips 120.2 that are in self-locking operative engagement 122 in the through-openings 116.4 in the lower rail 116.

Each cover 120 can optionally also comprise a cover strip 124, in particular a T-shaped plastics cover strip.

The cover strip 124 can in turn be releasably connected firmly to the carrier 120.1, in the form of a plastics carrier, via further clip-fastening connections and guides (not illustrated).

To cover a rail opening 116.5 formed between the two rail legs 116.2, a roller spring (not illustrated in more detail) can be provided. To guide the roller spring, in particular a leaf spring, a guide 126 is formed between the cover strip 124 and the carrier 120.1, adjoining the rail opening 116.5. An underside 124.1 of the cover strip forms an upper sliding surface or upper guide surface and a top side 120.1.1 of the carrier 120.1 forms a lower sliding surface or lower guide surface for the roller spring.

### LIST OF REFERENCE SIGNS

100 Vehicle seat
102 Seating part
104 Backrest
106 Fitting
108 Axis of rotation
110 Longitudinal adjustment device
112 Rail arrangement
114 Rail element, in particular first rail element (upper rail)
116 Rail element, in particular second rail element (lower rail)
116.1 Rail bottom
116.2 Rail leg
116.3 Free leg end
116.4 Through-opening
116.4.1 Upper edge (upper opening rim)
116.5 Rail opening
120 Cover
120.1 Carrier
120.1.1 Top side
120.2 Clip
120.2.1 Undercut
120.2.2 Rotary wedge
120.2.3 Locking contour
120.2.4 Free arm end
120.2.5 Cutout
120.2.6 Side
120.3 Second leg portion
120.4 Recess
120.4.1 Passage
120.4.2 Cutout
120.5 Free end
120.6 First leg portion
120.6.1 Free leg end
122 Self-locking operative engagement
124 Cover strip
124.1 Underside
126 Guide
200 Arrow
202 Pivot point
204 Contact point
206 Arrow
208.1 First bearing point
208.2 Second bearing point
210 Arrow (direction)
R1, R2 Arrow (locking direction)
x Longitudinal direction
y, +y, −y Transverse direction
z, +z Vertical direction

What is claimed is:

1. A cover for a rail element of a longitudinal adjustment device, comprising at least one carrier,
wherein the carrier is in the form of a plastics profile into which a plurality of clips are integrated which are spaced apart from one another along the longitudinal extent of the plastics profile and are each in the form of a rotary wedge.

2. The cover as claimed in claim 1, wherein each clip is pivotable about a pivot point.

3. The cover as claimed in claim 1, wherein each clip is preloaded in a direction oriented perpendicularly to the longitudinal extent.

4. The cover as claimed in claim 1, wherein each clip has at least one locking contour, wherein each locking contour is in the form of a wedge surface at a free arm end of each clip.

5. The cover as claimed in claim 1, wherein the plastics profile has a plurality of cutouts, which are spaced apart from one another along the longitudinal extent.

6. The cover as claimed in claim 5, wherein a clip is assigned to each cutout, wherein each clip is arranged in a protruding manner on one side of the cutout.

7. The cover as claimed in claim 1, wherein the plastics profile has a plurality of recesses for a latching plate of the longitudinal adjustment device and/or for a cover-strip fastener of a cover strip, wherein the clips and the recesses are arranged alternately along the longitudinal extent of the plastics profile.

8. The cover as claimed in claim 1, wherein the plastics profile has at least one undercut, which is arranged at a distance from the clips and is oriented substantially parallel thereto.

9. The cover as claimed in claim 8, wherein the plastics profile has a first leg portion and a perpendicularly protruding second leg portion connected to the first leg portion, wherein the undercut is formed at a free leg end of the first leg portion and the plurality of clips are integrated in the second leg portion.

10. A rail element for a longitudinal adjustment device, wherein the rail element comprises at least one rail bottom and two rail legs protruding perpendicularly therefrom, and at least one cover as claimed in claim 1, which is arranged on one of the two rail legs.

11. The rail element as claimed in claim 10,
wherein the rail leg has, along its longitudinal extent, a number of through-openings which are formed in a manner corresponding to the clips of the cover, wherein each clip passes into self-locking operative engagement in the associated through-opening.

12. The rail element as claimed in claim 10, wherein the rail leg has a free leg end, wherein the undercut of the cover engages around or behind the free leg end.

13. A vehicle having at least one vehicle seat and a longitudinal adjustment device for longitudinally adjusting the vehicle seat, wherein the longitudinal adjustment device comprises at least one rail arrangement with at least a first rail element and a second rail element as claimed in claim 10.
